(19) United States
(12) Patent Application Publication
(10) Pub. No.: US 2005/0156895 A1
(43) Pub. Date: Jul. 21, 2005

(54) Portable put-on keyboard glove

(76) Inventor: Tien-Hwa Ho, Taipei City (TW)

Correspondence Address: Tien-Hwa Ho, P.O. Box No. 6-57, Junghe, Taipei, 235, TW

(21) Appl. No.: 11/000,966

(22) Filed: Dec. 2, 2004

(30) Foreign Application Priority Data
Dec. 24, 2003 (TW) 092136780

(51) Int. Cl. G09G 5/00

(52) U.S. Cl. 345/168

(57) ABSTRACT

A portable put-on glove keyboard method, which uses fingers to contact pressure sensor devices near various points at a glove body and readily input text and number data, includes a glove body, a finger keyboard sensor array module, a transmission module, a power module and a system control module. The invention is characterized that, by contacting numerous points that can naturally come into contact with one another on the glove, the invention provides a novel method for replacing conventional keyboard input methods.

### BACKGROUND OF THE INVENTION

(a) Field of the Invention

The invention relates to a put-on keyboard glove, and more particularly, to a put-on keyboard glove that provides a method more convenient for inputting characters including texts and numbers compared with prior keyboards.

(b) Description of the Prior Art

Prior arts providing methods for inputting texts and numbers include means of keyboards, computer mice and pressure sensors. In other cases, a monitor is utilized to serve as buttons or to aid in character recognition, so as to input text and number data or to manipulate various devices. Several examples shall be given below.
1. The Taiwan Patent Publication No. 142054 dated Sep. 11, 1990, discloses a portable data inputting device. The device uses a box body that can be held by fingers, a barcode scanner and a keyboard for inputting numbers, as a device for inputting data.
2. The Taiwan Patent Publication No. 222028 dated Apr. 1, 1994, discloses a keyboard and data inputting device. The device uses a keyboard with different angles as an extension design to be more user-friendly.
3. The Taiwan Patent Publication No. 331951 dated May 11, 1998, discloses a keyboard having direction buttons accessible by thumbs and a roller.
4. The Taiwan Patent Publication No. 464016 dated Nov. 11, 2001, discloses an inputting device, which uses a sensor plane between a hand and a sensor, so as to improve drawbacks of an unstable cursor to better control the cursor.
5. The Taiwan Patent Publication No. 516358 dated Jan. 1, 2004, discloses an inputting device and an auxiliary inputting device, which enable some of the fingers to clamp a keyboard device, so as to facilitate other fingers to proceed with inputting operations of the keyboard.
6. The Taiwan Patent Publication No. 518506 data Jan. 21, 2003, discloses a character inputting device, which has buttons categorized into consonants and vowels.

There are also inputting devices that operate in conjunction with gloves, and shall be listed below.
7. The Taiwan Patent Publication No. 105276 dated Nov. 11, 1988, discloses a musical glove toy, which has five sets of spring switches between linings of a glove body thereof to determine different sounds outputted by a music integrated circuit.
8. The Taiwan Patent Publication No. 293898 dated Dec. 21, 1996, discloses a 3-dimensional digital glove and a control system thereof. The device acquires parameters of 3-dimensional positions and interactive controls by recognizing degrees of fingers being bent and positions of the glove.
9. The Taiwan Patent Publication No. 479209 dated Mar. 11, 2002, discloses a virtual reality interface producing device, which uses a glove and a tracking device to execute a virtual reality capable of interaction functions.

Due to fast advancement of information technology, it is essential to provide a data inputting method than can be readily implemented in a convenient and comfortable manner. A conventional computer keyboard, a character recognition panel and even number buttons of a cell phone, all need an external inputting body for a user to input data using buttons or enter characters. Therefore, under various circumstances, users are resulted with complications. For instance, a conventional keyboard and a character recognition method is hardly practical. In addition, handheld digital devices are being developed toward being small in size, meaning that conventional inputting devices are getting more and more inconvenient. A good example is a cell phone having only number buttons, using which Chinese and English characters can hardly be entered with ease. Same difficulties are also incurred using a digital device such as a PDA for that a speed of hand-writing Chinese and English characters is far slower than using a keyboard, provided that a user is familiar with a keyboard. Supposed an externally connected keyboard is used, the PDA then becomes deprived from its original convenience. Above, the hand-written method and character recognition of a PDA is an obstacle that cannot be conquered for those who are visually challenged.

### SUMMARY OF THE INVENTION

The primary object of the invention is to provide a portable put-on glove keyboard inputting method offering a most natural means for inputting characters. To be more precise, without affecting original movements of a user's body and without requiring any handheld inputting devices, the invention can input all kinds of data under all circumstances.

A portable put-on glove keyboard method according to the invention uses fingers to contact pressure sensor devices near various points at a glove body to serve as input devices of text and number data. The invention comprises a glove body, a finger keyboard sensor array module, a transmission module, a power module and a system control module. Using a glove made of a thin material, linings near various hand joints are embedded with numerous pressing sensor membranes to arrange into contact and pressing points of different characters, and thus forming a glove keyboard device. In conjunction with different finger movements, text and number characters can be inputted. The glove keyboard according to the invention can also be connected to a digital device using wireless or wired means to serve as a main or auxiliary keyboard to readily and speedily inputting Chinese and English characters.

Without affecting normal operations of hands, when wearing the glove according to the invention, using finger movements upon the pressure sensor devices attached to the glove body, various characters can be inputted while walking or taking a bus, thereby providing a most natural input method for replacing conventional input methods. Even when taking public transportation, a novel input method more convenient than prior arts and using simple finger movements can be accomplished. For example, text and number data can be inputted while walking, and song writing and composing can be done through simple finger movements. Other examples of applications of the invention are simple input ends of a calculator, a real-time Chinese-English translating device, other remote control devices and even all information household appliances and digital devices. Using a portable put-on glove keyboard according to the invention, text and number characters can be inputted at all times and under all circumstances. The invention also provides a most appropriate input method for those who are physically or mentally challenged because only most natural finger movements and no visual means are needed when wearing the glove. Different key configurations can be adjusted to adapt to users using a left hand, a right hand, or both hands. Furthermore, the invention can be connected to a system such as a computer, a PDD or a cell phone, with data being temporarily stored at the system control module, and then outputted in sequence once an appropriate information system is later connected. Thus, a student is allowed to temporarily store data in the glove keyboard for school or for meetings. Above all, using same procedures as practicing with prior keyboards, data input can be more speedily accomplished using the method according to the invention with which a user is familiarized with character and corresponding positions of the glove keyboard. In the era with vigorous information development, the invention indeed brings users with immense practical values.

### BRIEF DESCRIPTION OF THE DRAWINGS

FIG. 1 shows a structural schematic view of a glove keyboard module according to the invention.

FIG. 2 shows points coming into contact using finger movements in an embodiment according to the invention.

FIG. 3 shows Table 3a, 3b, 3c correspondence between characters and fingers in an embodiment according to the invention.

### DETAILED DESCRIPTION OF THE PREFERRED EMBODIMENTS

To better understand functions and characteristics of the invention, detailed descriptions of preferred embodiments shall be given with the accompanying drawings below.

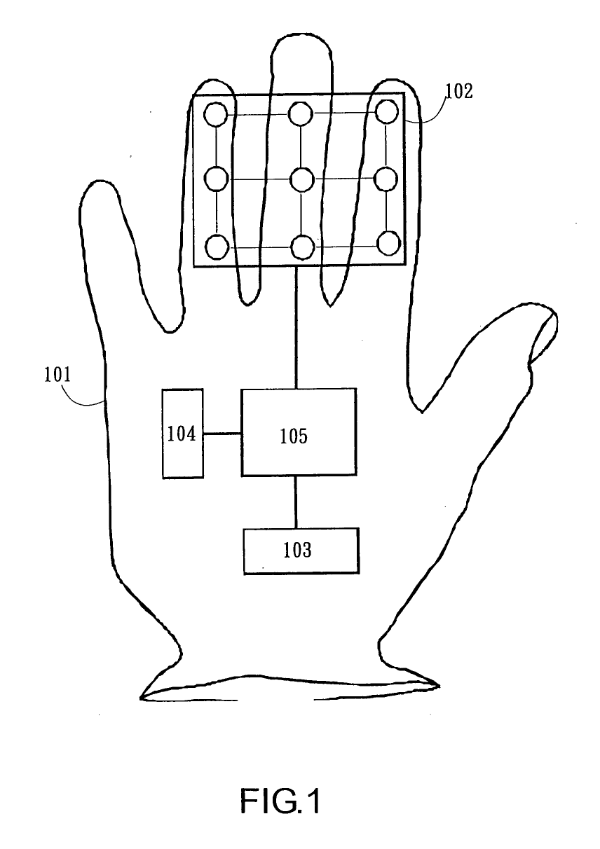

Referring to FIG. 1, a system according to the invention comprises a glove body 101, a finger keyboard sensor array module 102, a transmission module 103, a power module 104, and a system control module 105.

According to the method of the invention, the glove body 101 has the finger keyboard sensor array module 102 at an obverse side thereof, and the transmission module 103, the power module 104 and the system control module 105 embedded to a reverse side thereof. Using pressures from contact between a thumb, other fingers and a palm, corresponding information results of characters detected by the sensor array module 102 are forwarded to the system control module 105. According to settings configured by the user, the characters can be transmitted via the transmission module 103 to a connected information system using a wireless or wired means; or can be temporarily stored at the system control module 105, and then outputted in sequence once an appropriate information system is later connected.

Compared with the conventional keyboard and the hand-written character recognition method, the invention provides an inputting method by directly putting on a keyboard glove without requiring other handheld devices as inputting tools, thereby offering a more handy, direct and natural input method when put to application. One of the characteristics of the invention is that, different points that can come into contact with one another exist at fingers and various joints of a human hand, are used to identify different easily accessible locations corresponding to many pressure sensor array regions at the glove body to arrange into positions of different text and number buttons, thereby forming a glove keyboard. The positions of buttons of the keyboard cover all joint areas naturally formed, sides of fingers and portions of the palm when fingers are bent. Long since, these points accessible by fingers have been adopted in numbers for fortune-telling and calculating calendar years, months and days. Through novel designs and configurations in addition to combination sensor points, the accessible points are adjusted into efficient character input button points. Furthermore, contact movements between the thumb, fingers and palm are considered as familiar actions in people's daily lives. These actions have relatively short displacement distances, and thus can be implemented more instinctively with minimal effort and lower entry barrier. Therefore, supposed the input method according to the invention is extensively applied, people are allowed to more rapidly enter information including texts and numbers in a more natural way compared to the conventional keyboard.

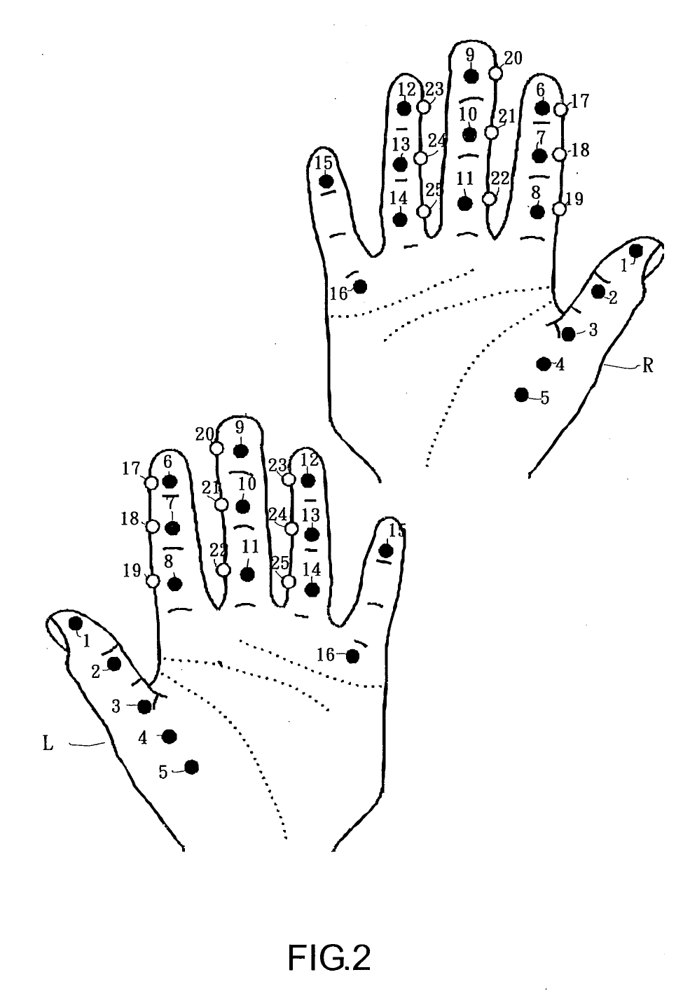

Referring to FIG. 2 showing an embodiment of the inputting method using accessible points according to the invention, various points that can come into contact with one another of the fingers and palm are used as sensor areas, and thus FIG. 2 is only for illustrating an example and various modifications made based on such principle that is to be embraced by the method according to the invention. As shown in FIG. 2, L(1) to L(25) are various points at a right hand, and R(1) to R(25) are various points at a left hand. Take the right hand for instance, R(1) to R(5) are joints at a thumb, and white circles at L(17) to L(25) represent sensor areas located at sides of the fingers. Conforming to ergonomics of thumb movements, another aforesaid characteristic of the invention lies within logical analysis range of modern sensor technologies, and hence numerous points can be derived from sides of the fingers.

Again referring to FIG. 2, (1) at a tip of the thumb is used as a main control point, and except (2) to (5), all (6) to (25) can be contacted by (1) to produce signals using the sensor array module by applying appropriate forces. At this stage, 20 characters can be outputted by a right hand alone. Take a character (1-6) for example, it is produced by selecting a point (6) using (1) as a control point. Similarly, when a point (2) is contacted with (17), another character (2-17) is produced, and so on for (2-18), (2-19), (6-3), (9-4) and (12-5). Therefore, in conjunction with the thumb, 6 different characters can be derived. The above description only includes results by contacting two points, and supposed combinations of other points are used, more different results can be produced. For instance, when (12-5) is pressed, using the thumb to control the point (1), (6) can still be smoothly selected to produce a character (12-5) +(1-6). Other points (7), (9), (10), (11), (17), (18), (20), (21), and (22) can also come into contact with (1) to again produce 10 more combinations. Likewise, when (9-4) is pressed, (1-6), (1-7), (1-17) and (1-18) are offered with four additional combinations. Conclusive from the aforesaid description, in an embodiment according to the invention, 40 combinations are derived and thus forming 40 different characters.

Other fingers and even the left and right hands can be used at the same time to derive all kinds of combinations and thus forming many different characters. However, all these modifications shall be contained by a principle according to the invention as “contacting different points of fingers and joints of a human hand to serve as an outputting method”.

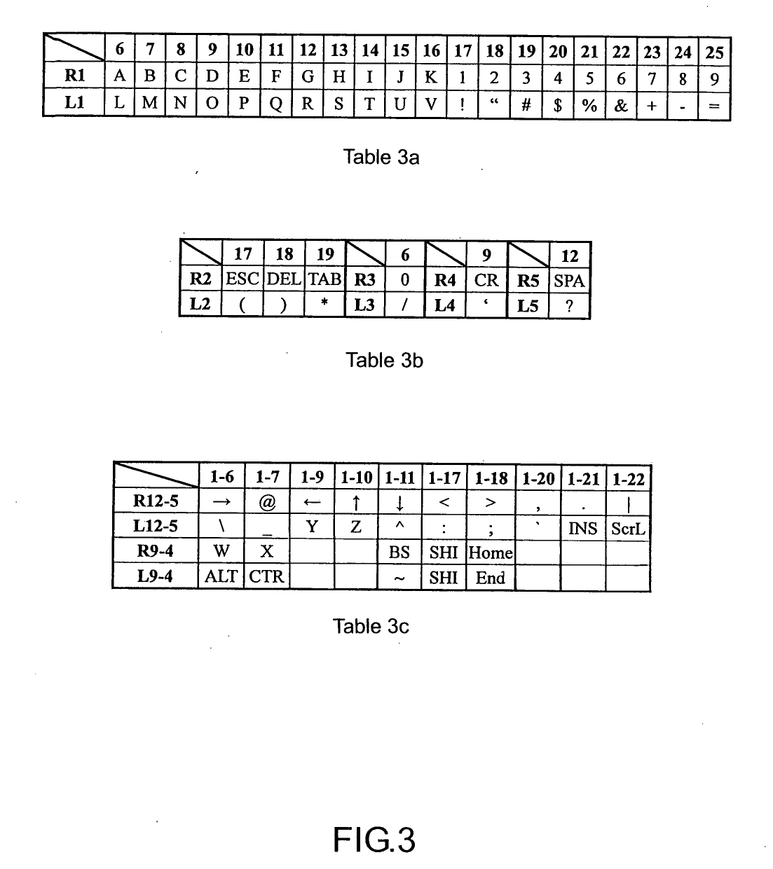

For that the left hand can have the same combinations, 80 different combinations are provided to arrange into an effective keyboard for outputting characters. Referring to FIG. 3 showing an embodiment using both hands according to the invention, the characters are not defined by a frequency of appearance nor degrees of difficulty of contact movements between the points of fingers. Referring to Table 3a, R1 represents the (1) point of the right hand, and is corresponded with values in the array (6) to (25) to derive characters of buttons using those points. Take A represented by (R1, 6) in the array for example, it means that character “A” is produced by contacting the point (1-6). L represents characters produced using the left hand. Therefore, (L1, 25) forms a symbol character of “=”. The characters listed in Table 3a are more common and visible characters; whereas, a character “ESC” represented by “R2, 17) in Table 3b is a non-visible character and is also an “escape” character standardized by American Standard Code for Information Interchange (ASCII). Table 3c lists combinational keys. Control characters and symbols used in Tables 3b and 3c are also listed below.
(R2-17): Esc
(R2-18): Del
(R2-19): Tab
(R4-9): Cap
(R5-12): Space
(R12-5)+(1-6):←
(R12-5)+(1-9):←
(R12-5)+(1-10):↑
(R12-5)+(1-11):↓
(L12-5)+(1-21): Ins
(L12-5)+(1-22): Scroll
(L9)-4)+(1-6): Alt
(L9)-4)+(1-7): Ctrl
(R9-4)+(1-11): Backspace
(R9/L9-4)+(1-17): Shift
(R9-4)+(1-18): Home
(L9-4)+(1-18): End

For example, a backspace command is formed when (R9-4) at the right hand is pressed followed by pressing (1-11), and an insert command is formed followed by pressing (1-21). Supposed a user requires continuous backspace commands, this objective is easily accomplished by fingers of the user. Apparent from the aforesaid description, it is observed that another characteristic of the invention is that different control keys such as Esc and Insert commands can be achieved by simple finger movements. This characteristic is unlikely accomplished by hand-written character recognition systems, and cell phone keyboard having only text and number buttons.

Another secondary characteristic of the invention is that, when four fingers of a glove is adjacently located to form a plane, a thumb is allowed to glide thereon using the sensor array to analyze the points at the glove, such that a control panel on which a mouse can move is simulated. Referring to FIG. 2, when all or most of the points between (20), (21), (22), and (23), (24), (25) are simultaneously touched, it is indicated that the fingers are adjacently located. At this moment, the system control module switches the glove keyboard to a mouse control panel mode. Owing to the sensor points (6) to (14) being not represented by a single point but forming a small planar array, when a user moves the point (1) across the planar array formed by the points (6) to (14), results of a moved track detected by the sensor are forward to the control module for further process, thereby accomplishing an object of simulating a mouse control panel. Using joining and separating movements of fingers to switch between mouse and keyboard modes, the invention provides an effective and user-friend operation as well as satisfying ergonomic requirements.

According to the invention, points at a single hand already exceeds a number of buttons offered by certain information or control devices, and therefore a user is allowed to configure the input method by using a right hand, a left hand, or both hands. Taking frequencies of appearance of characters, and degrees of difficulties of contact movements between points of fingers, or symbols in a Chinese input method into consideration, the method according to the invention easily arranges various key-character look-up tables. However, different combinations and configurations using the method according to the invention shall be included in the scope of the invention.

People have long since used conventional keyboards as an input tool, and have only mastered the conventional keyboards with long-term practice. The invention skillfully employs different points that come into contact with one another at fingers and palms of human hands as basis for input keys to provide a great number of points, which can be selected as keys. In addition, the invention is readily coordinated with modern wireless technologies including infrared, Bluetooth or other wireless networks, laptops, PDAs, message cell phones, and IA household appliances with built-in Bluetooth and infrared functions, such that the glove keyboard according to the invention can be used for inputting text and number data or for remote controlling commands. In the era with vigorous information development, the invention indeed brings users with immense practical values.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A portable put-on glove keyboard method, which uses fingers to contact pressure sensor devices near various points at a glove body and readily input text and number data or give remote control commands via wireless or wired transmission means, comprising a glove body, a finger keyboard sensor array module, a transmission module, a power module and a system control module; and being characterized that, when wearing the glove, pressure sensor devices attached to the glove body are touched by finger movements to output different characters arranged by input keys, and points that can come into contact with one another at fingers and a palm are used as input points, thereby accomplishing a natural and portable input method achieved by simple finger movements and thus replacing conventional input methods.

2. The portable put-on glove keyboard method in accordance with claim 1 further comprising a characteristic that, points that can come into contact with one another and located with appropriate distances in between at fingers and a palm, are corresponded with positions of pressure sensor arrays at the glove body to configure into positions of text and number keys using different contact and pressing points, thereby forming a glove keyboard; wherein, positions of keys of the keyboard are consisted of positions at joints, sides of fingers, and a palm when fingers are bent.

3. The portable put-on glove keyboard method in accordance with claim 1 further comprising a characteristic that, using combinations of the pressing and contact points, several fingers are moved at the same time to execute combinational keys, thereby expanding a number of character input keys using limited press and contact points.

4. The portable put-on glove keyboard method in accordance with claim 1, wherein key configurations at the glove and the input method are adjustable for users using a left hand, a right hand, or both hands.

5. The portable put-on glove keyboard method in accordance with claim 1, wherein when four fingers of the glove are adjacent located to form a plane, a thumb is allowed to glide thereon using the sensor array to analyze the points at the glove, such that a control panel on which a mouse can move is simulated; and the mouse and keyboard modes are switched using separating movements of the fingers, thereby providing multi-functional mouse touch panel and text and number character keyboard functions.

6. The portable put-on glove keyboard method in accordance with claim 1, wherein the method is connected to other information devices using wireless or wired means to serve as a main or auxiliary keyboard for directly inputting data into a digital device such as a computer, a PDA or a cell phone; or to accomplish an independent operation, in which inputted information is temporarily stored at a memory at the glove and then outputted in sequence once an appropriate information system is later connected.

7. The portable put-on glove keyboard method in accordance with claim 1 further comprising a characteristic that, several other fingers can be used at the same time, or even degrees of pressing forces from fingers of left and right hands are be used to derive various configurations of finger movements, thereby increasing a number of characters or serving for other purposes.
